(19) United States
(12) Patent Application Publication
(10) Pub. No.: US 2026/0319172 A1
(43) Pub. Date: Oct. 15, 2026

(54) DIAMOND LAYER ON PHOTONIC CIRCUIT

(71) Applicant: Element Six Technologies Limited, Didcot Oxfordshire (GB)

(72) Inventor: Teodoro GRAZIOSI, Harwell, Oxfordshire (GB)

(21) Appl. No.: 19/117,285

(22) PCT Filed: Sep. 27, 2023
(86) PCT No.: PCT/EP2023/076703

§ 371 Date: Mar. 31, 2025

(30) Foreign Application Priority Data
Oct. 3, 2022 (GB) 2214512.2

(51) Int. Cl. G02B 6/122; G02B 6/13

(52) U.S. Cl. CPC G02B 6/122; G02B 6/13

(57) ABSTRACT

A Photonic Integrated Circuit (PIC) and a single crystal diamond layer disposed on the PIC. The single crystal diamond substrate comprises at least one spin defect, and has a largest surface with a surface area of at least 250,000 μm². The PIC comprises at least one alignment structure and the single crystal diamond layer comprises at least one corresponding diamond alignment structure. The PIC further comprises at least one photonic structure optically coupled to the at least one spin defect.

### FIELD OF THE INVENTION

The present invention relates to photonic circuits with diamond layers, and method of forming photonic circuits with diamond layers.

### BACKGROUND OF THE INVENTION

Spin defects in synthetic diamond material, particularly quantum spin defects and/or optically active defects, have been proposed for use in various sensing, detecting, and quantum processing applications including: magnetometers; spin resonance devices such as nuclear magnetic resonance (NMR) and electron spin resonance (ESR) devices; spin resonance imaging devices for magnetic resonance imaging (MRI); and quantum information processing (QIP) devices such as for quantum computing.

A problem with quantum materials is that a single photon emission from quantum spin defects in such materials can be very weak. For example, NV⁻ defects in diamond exhibit a broad spectral emission associated with a Debye-Waller factor of the order of 0.05, even at low temperature. Emission of single photons in the Zero-Phonon Line (ZPL) is then extremely weak, typically of the order of a few thousands of photons per second. Such counting rates might be insufficient for the realization of advanced QIP protocols based on coupling between spin states and optical transitions within reasonable data acquisition times.

In addition to the problem of weak emission, the high refractive index of diamond material means that due to total internal reflection very few photons can be collected within a small solid angle. Accordingly, there is a need to increase the light collection from quantum spin defects in diamond material for applications that include quantum information processing.

In order to create an effective photonic circuit, the spin defects in the diamond must therefore be accurately optically coupled to waveguides in the Photonic Integrated Circuit (PIC) on which the diamond is mounted.

A limitation to the wider adoption of diamond for quantum technologies is the difficulty in processing photonic circuits since large area single crystal diamond is not easily available as a thin film of few hundreds of nm over a PIC.

A photonic circuit typically comprises a handle layer, cladding layer(s) and a waveguiding or active layer. The waveguiding layer is typically formed from silicon nitride, gallium phosphide or aluminium nitride as these have the required transparency at the typical emission wavelengths of diamond defects such as NV⁻ and SiV centres. The diamond may be structured with spin defects in certain location that must match up with corresponding optical waveguides in the PIC. This is difficult to achieve with large area single crystal diamond layers.

It is desirable to achieve low-loss interconnects (<0.1 dB/cm is possible) between different spin defects. The added functionalities of a developed photonic circuit, such as splitters, interferometers, delay lines, and resonators can be exploited. Low loss waveguides and other photonic structures are difficult to fabricate in single crystal diamond due to the difficulty of microfabrication caused by the strong chemical inertness of single crystal diamond.

Furthermore, materials such as SiN have high non-linear coefficients, allowing for photon-pair generation and photon frequency conversion, which could be used for the implementation of quantum computing and quantum communication protocols, in addition to the operations supported by the diamond defects spin qubits.

The integration of a diamond layer on a large area substrate can help with integrating further elements thanks to the improved compatibility with standard clean room microfabrication techniques. One example would be the fabrication of microwave waveguides for the control of the diamond defect spin, or the co-integration of other components such as single photon detectors.

### SUMMARY

It is an object to provide a photonic circuit with a large area single crystal diamond layer containing spin defects that are accurately optically coupled to waveguides and other structures in a waveguiding layer in a photonics integrated circuit.

According to a first aspect, there is provided a PIC (for example, comprising a waveguiding layer and a cladding layer) and a single crystal diamond layer disposed on the PIC. The single crystal diamond substrate comprises at least one spin defect, and has a largest surface with a surface area of at least 250,000 μm². The PIC comprises at least one alignment structure and the single crystal diamond layer comprises at least one corresponding diamond alignment structure. The PIC further comprises at least one photonic structure optically coupled to the at least one spin defect.

As an option, the spin defect is selected from any of a negatively charged nitrogen-vacancy centre, a silicon vacancy centre, a germanium vacancy centre, a tin vacancy centre, a nickel vacancy NE4, and a nickel vacancy nitrogen defects, NE8.

The photonic circuit optionally comprises a plurality of spin defects and a plurality of corresponding photonic structures, wherein the plurality of photonic structures are configured to connect different spin defects in accordance with quantum computing protocols.

Examples of photonic structure include optical waveguides and photonic cavities.

As an option, the single crystal diamond layer has a thickness selected from any of between 50 nm and 50 μm, 100 nm and 10 μm, and 150 nm and 5 μm.

The PIC alignment structure and the diamond alignment structure optionally comprise corresponding structures that allow light to pass through when the alignment structures are aligned. It will be appreciated that alignments is as close as possible when the amount of light that passes through is maximised.

In an optional embodiment, the PIC alignment structure and the diamond alignment structure comprise corresponding diffraction gratings arranged to diffract light during alignment.

In an optional embodiment, the PIC alignment structure and the diamond alignment structure comprise corresponding waveguide couplers in the diamond layer to connect optical waveguides in the PIC.

Note that a combination of the two embodiments described above may be used; diffracting gratings may be used to achieve a rough alignment, and waveguide couplers may then be used to achieve a more precise alignment.

As a further option, the PIC alignment structure and the diamond alignment structure comprise alignment markers.

The PIC alignment structure and the diamond alignment structure are optionally formed using any of implantation, electron beam lithography and inductively couple plasma reactive ion etching.

As an option, the single crystal diamond layer has a largest surface area selected from any of at least 500,000 μm², 1 mm², 4 mm², 25 mm²and 100 mm². As diamond layers become larger in area, alignment becomes more difficult and more critical.

As an option, a plurality of single crystal diamond layers are disposed on the PIC.

According to a second aspect, there is provided a method of forming a photonic circuit. The method comprises providing a PIC, and disposing a single crystal diamond layer on the PIC by aligning a diamond alignment structure in the diamond layer with a corresponding PIC alignment structure in the PIC. The single crystal diamond layer has a largest surface with a surface area of at least 250,000 μm²; and comprises at least one spin defect, the spin defect being optically coupled to an optical waveguide in the PIC after alignment.

The spin defect is optionally selected from any of a negatively charged nitrogen-vacancy centre, a silicon vacancy centre, a germanium vacancy centre, a tin vacancy centre, a nickel vacancy NE4, and a nickel vacancy nitrogen defects, NE8.

As an option, the diamond layer comprises a plurality of spin defects and the PIC comprises a plurality of corresponding photonic structures, wherein the plurality of photonic structures are configured to connect different spin defects in accordance with quantum computing protocols.

Optional examples of the photonic structure include any of an optical waveguide and a photonic cavity.

As an option, the PIC alignment structure and the diamond alignment structure comprise corresponding structures that allow light to pass through when the alignment structures are aligned, and the alignment step comprises passing light through the alignment structures. In this step, when the intensity of light passing through is maximised, then the closest alignment is achieved.

As an option, the PIC alignment structure and the diamond alignment structure comprise corresponding diffraction gratings, and the alignment step comprises passing light through the diffraction gratings.

As an option, the PIC alignment structure and the diamond alignment structure comprise corresponding waveguide couplers in the diamond layer to connect waveguides in the PIC, and the alignment step comprises passing light through the waveguide couplers.

As an option, the PIC alignment structure and the diamond alignment structure comprise alignment markers, and the alignment comprises aligning corresponding alignment markers.

As an option, and prior to aligning the diamond alignment structure in the diamond layer with a corresponding PIC alignment structure in the PIC, PIC alignment structures and diamond alignment structures are formed using any of implantation, electron beam lithography and inductively couple plasma reactive ion etching.

In an optional embodiment, a plurality of single crystal diamond layers are disposed on the PIC.

As an option, and prior to disposing the diamond layer on the PIC, the method comprises forming the spin defect in the diamond layer, mapping the location of the spin defect in the diamond layer, and forming the photonic structure in the PIC to correspond to the location of the spin defect such that the spin defect and the photonic structure are optically coupled after disposing the diamond layer on the PIC.

As an alternative option, the method comprises forming the photonic structure in the PIC, disposing the diamond layer on the PIC, and forming the spin defect in the diamond layer such that the spin defect and the photonic structure are optically coupled. Note that the steps of disposing the diamond layer on the PIC and forming the spin defect in the diamond layer may be in any order.

### BRIEF DESCRIPTION OF THE DRAWINGS

Some embodiments of the invention will now be described by way of example only and with reference to the accompanying drawings, in which:

FIG. 1 illustrates schematically a side elevation cross section view of an exemplary PIC;

FIG. 2 illustrates schematically a side elevation cross section view of an exemplary PIC and a corresponding diamond layer;

FIG. 3 illustrates schematically a side elevation cross section view of an exemplary PIC and a corresponding diamond layer with the diamond layer aligned with the PIC;

FIG. 4 illustrates schematically a plan view of an exemplary photonic circuit comprising an PIC and a corresponding aligned diamond layer;

FIG. 5 illustrates schematically a side elevation cross section view of a further exemplary PIC and a corresponding diamond layer with the diamond layer aligned with the PIC;

FIG. 6 illustrates schematically a side elevation cross section view of a further exemplary PIC and a corresponding diamond layer with the diamond layer aligned with the PIC;

FIG. 7 is a flow diagram showing exemplary steps to form a photonic circuit;

FIG. 8 is a flow diagram showing further exemplary steps to form a photonic circuit; and

FIG. 9 is a flow diagram showing alternative exemplary steps to form a photonic circuit;

### DETAILED DESCRIPTION

In order to accurately align a large are single crystal diamond layer with a corresponding PIC to form a heterogeneously integrated photonic circuit, the PIC is provided with at least one PIC alignment structure and the diamond layer is provided with at least one corresponding diamond alignment structure.

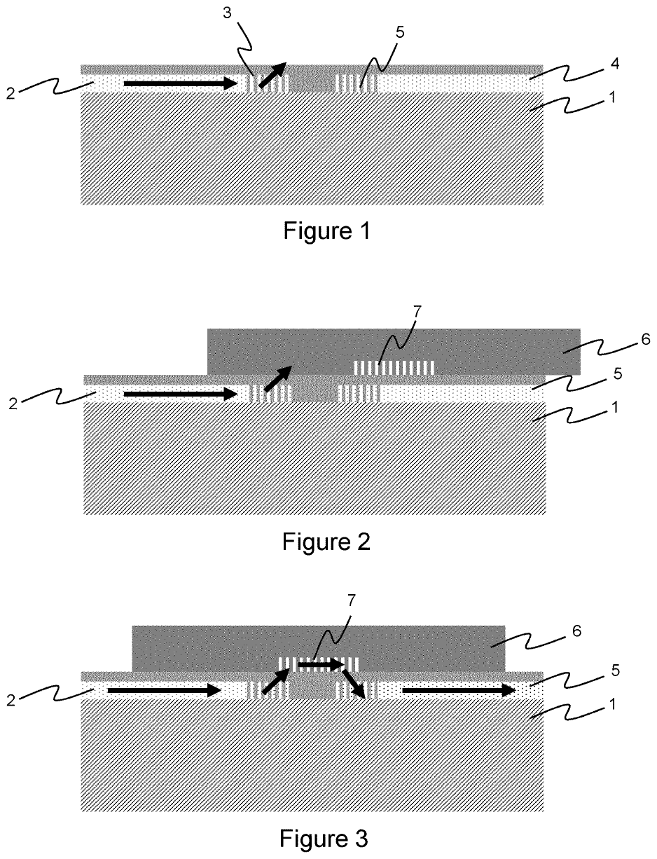

To illustrate the processes and structures, in a first example and with reference to FIGS. 1 to 3, the alignment structures are assumed to be diffraction gratings.

FIG. 1 illustrates schematically a side elevation cross section view of a PIC 1 that is provided with a first alignment optical waveguide 2. The first alignment optical waveguide 2 is located close to a surface of the PIC 1 and terminates in a first PIC diffracting grating 3. A second alignment optical waveguide 4 is also provided close to a surface of the PIC 1. The second alignment optical waveguide 4 terminates in a second PIC diffracting grating 5. The first and second diffracting gratings 3, 5 are not optically coupled to one another, so if light (shown in FIG. 1 as a black arrow) is passed through the first alignment optical waveguide 2 it will not subsequently pass through the second alignment optical waveguide 4.

Turning now to FIG. 2, a diamond layer 6 is provided that is provided with a diamond diffracting grating 7. When the diamond layer is placed on the surface of the PIC 1, but without aligning the diffracting gratings 3, 5, 7, light passed through the first alignment optical waveguide 2 will still not subsequently pass through the second alignment optical waveguide 4 because the light is scattered out of plane. When the diamond layer 6 is in close (but not full) alignment with the PIC 1, the alignment signal is partially reflected to the same waveguide or an adjacent waveguide (depending on the design). Using a multi-axis micromanipulator, the position of the diamond layer 6 relative to the PIC 1 is optimized by monitoring the optical signal, and the optimal position is reached when the reflected signal is maximized. Multiple gratings can be used to increase the alignment accuracy.

As shown in FIG. 3, when the diffracting gratings 3, 5, 7 are aligned then light passed through the first alignment optical waveguide 2 is diffracted by the first PIC diffracting grating 3 so that it is directed into the diamond diffracting grating 7. The light is subsequently diffracted from the diamond diffracting grating 7 such that it is directed into the second PIC diffracting grating 5. The light is then diffracted from the second PIC diffracting grating 5 into the second alignment optical waveguide 4. When light is detected from the second alignment optical waveguide 4 then the diamond layer 6 is properly aligned with the PIC 1.

It will be appreciated that multiple corresponding diffracting gratings at different angles may be used to ensure that the diamond layer 6 is aligned in two dimensions on the PIC 1.

Diffraction gratings may be realized, for example, using techniques such as Rigorous Coupled-Wave Analysis simulations and fabrication techniques including lithography and Inductively Coupled Plasma Reactive Ion Etching (ICP-RIE)

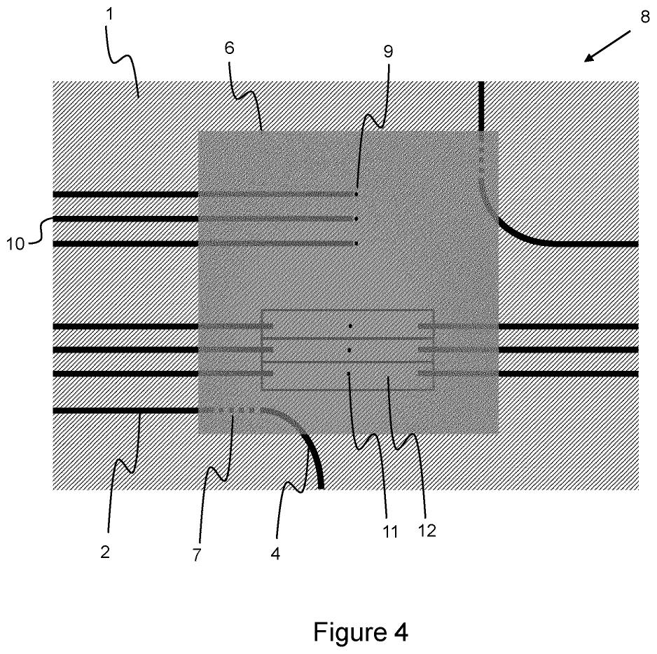

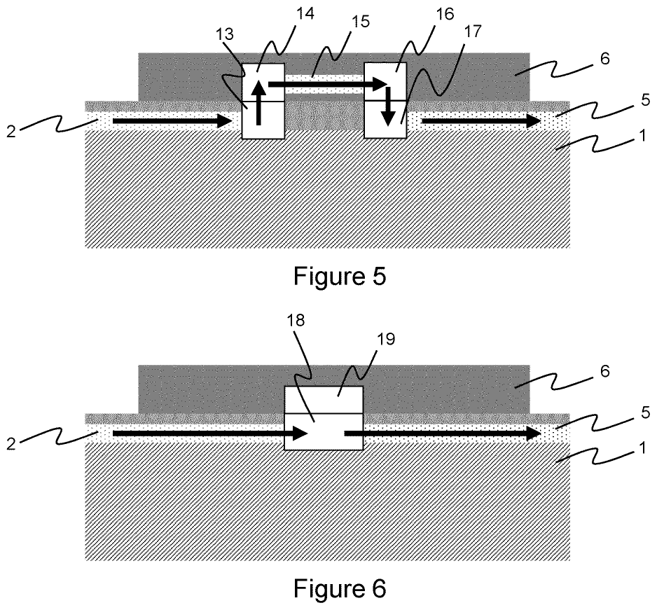

Turning now to FIG. 4, an exemplary photonic circuit 8 is illustrated in plan view. The heterogeneously integrated photonic circuit 8 comprises the PIC 1 with the diamond layer 6 disposed on the PIC 1. Alignment is performed as described above using diffracting gratings 7, and alignment optical waveguides 2, 4. In this example, the diamond layer 6 comprises three spin defects 9 optically coupled to corresponding waveguides 10 disposed in the PIC. By way of example, three more spin defects 11 in the diamond layer 6 are optically coupled to corresponding photonic cavities 12.

It can be seen that two sets of diffraction gratings and alignments optical waveguides are provided, with one set of diffraction gratings disposed at 90° to the other set of diffraction gratings, to ensure that alignment of the diamond layer 6 on the PIC 1 is effected in two dimensions.

While diffracting gratings are described in the example above, other types of optical coupling can be used, such as optical waveguides with adiabatic couplers. Like the example of the diffracting grating above, waveguides are structured in the diamond layer 6 before transfer. They are terminated with a tapered adiabatic coupler. On the PIC 1, an array of waveguides is fabricated. When the diamond layer 6 is in alignment with the PIC 1, the optical signal from one set of alignment waveguides in the PIC 1 is coupled to the next set of alignment waveguides in the PIC 1.

To illustrate a second exemplary way of aligning the substrate 1 with the diamond layer, FIG. 5 illustrates schematically a side elevation cross section view of a further exemplary PIC and a corresponding diamond layer with the diamond layer aligned with the PIC.

In the example of FIG. 5, the first alignment optical waveguide 2 is located close to a surface of the PIC 1 and terminates in a first substrate optical coupler 13. When the diamond layer 6 and the substrate are aligned, the first substrate optical coupler 13 optically connects to a first diamond optical coupler 14. The first diamond optical coupler 14 is connected by a diamond waveguide 15 to a second diamond optical coupler 16. A second substrate optical coupler 17 is provided at the surface of the substrate which optically connects to the second diamond optical coupler 16 when the diamond layer 6 is aligned with the substrate 1. When the two corresponding sets of optical couplers are aligned, light passed through the first alignment optical waveguide 2 can be detected at the second alignment optical waveguide 5. The diamond waveguide 15 may be a ridge waveguide, or a rib waveguide, or a slot waveguide, or a photonic crystal waveguide fabricated in the diamond layer prior to the transfer.

An advantage of the structure shown in FIG. 5 is that the corresponding sets of optical couplers can be off-set from one another, such that the diamond can be aligned in two dimensions by passing light through just the first alignment optical waveguide 2.

FIG. 6 shows a simpler version of the structure shown in FIG. 5. In this case the first alignment optical waveguide 2 terminates in a single substrate optical coupler 18, that does not allow light to pass from the first alignment optical waveguide 2 to the second alignment optical waveguide 5 unless the single substrate optical coupler 18 is aligned with a corresponding diamond optical coupler 19 in the diamond layer 6. In this example, at least a pair of corresponding optical couplers are required to align the diamond layer 6 with the PIC 1 in two dimensions.

The examples of alignment structures described above have different strengths and weaknesses, and an optimal setup could involve the use of diffracting gratings for a rough alignment and waveguide couplers for finer alignment. It will be appreciated that any other photonic structure that can be used to redirect an optical signal from one waveguide in the PIC to another may be used.

In addition to or instead of the alignment structures shown in FIGS. 1 to 6, the alignments structures may be simple markings that can be aligned visually or by automatic means to ensure that the diamond layer 6 is properly aligned with the PIC 1.

Note also that while large area diamond layers are used, it may be desirable to dispose a plurality of diamond layers on a single PIC to allow larger and more complex photonic circuits to be formed.

There are various ways to form alignment structures in both the diamond layer 6 and the PIC 1. These include implantation, electron beam lithography and inductively couple plasma reactive ion etching.

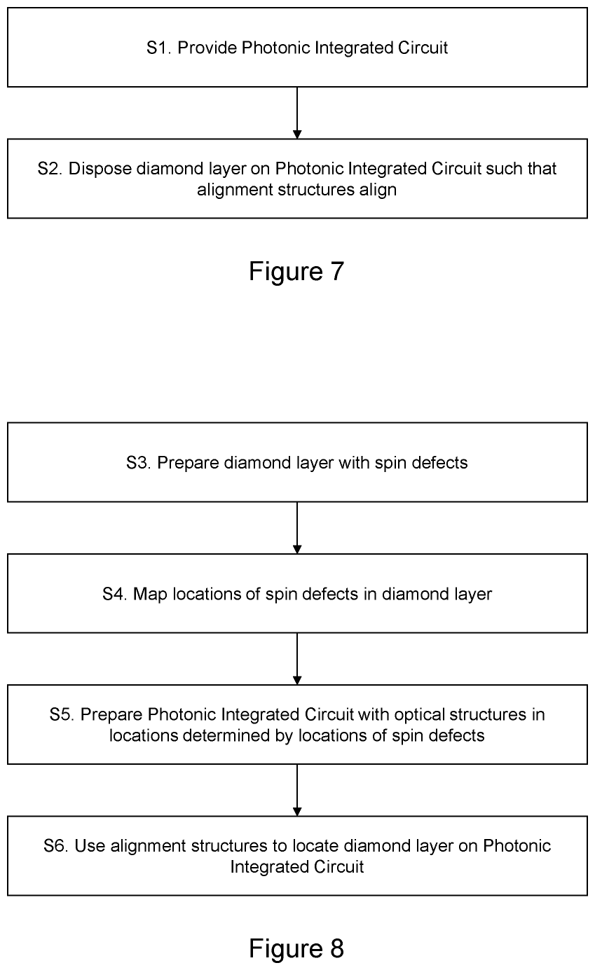

FIG. 7 is a flow diagram showing the exemplary steps described above. The following numbering corresponds to that of FIG. 7:
S1. An PIC is provided that comprises at least one PIC alignment structure, such as a diffraction grating, a waveguide coupler or an alignment marker. In most practical applications, at least two PIC alignment structures are provided.
S2. A single crystal diamond layer is disposed on the PIC by aligning a diamond alignment structure in the diamond layer with the corresponding PIC alignment structure in the PIC. The single crystal diamond layer has a largest surface with a surface area of at least 250,000 μm²; and comprises at least one spin defect. After alignment, the spin defect is optically coupled to an optical waveguide in the PIC. Exemplary spin defects are spin defect any of a negatively charged nitrogen-vacancy centre, a silicon vacancy centre, a germanium vacancy centre and a tin vacancy centre. In most cases, a plurality of spin defects are provided which are each optically coupled to a corresponding optical waveguide.

As described above, a key requirement for accurate alignment of the diamond layer 6 to the PIC 1 is so that spin defects are optically coupled to corresponding optical waveguides or other optical structures such as photonic cavities. In order to do this, the locations of the spin defects and the corresponding optical structures must be controlled to ensure optical coupling after alignment.

In a first example, the locations of the spin defects in the diamond layer 6 are mapped and the optical structures are then formed in the PIC 1 based on the known locations of the spin defects. FIG. 8 is a flow diagram showing exemplary steps for this method, with the following numbering corresponding to that of FIG. 8:
S3. A single crystal diamond layer 6 is prepared containing spin defects. There are several ways that spin defects can be incorporated into the diamond layer 6. For example, they can be added to the diamond crystal lattice when the diamond is grown in a CVD reactor. For example, as described in WO2010149775, nitrogen can be added to the process gas during growth, leading to nitrogen being incorporated into the diamond crystal lattice. With subsequent irradiation and annealing, some of the nitrogen can be converted to NV⁻ centres. An alternative way to incorporate spin centres into the diamond is by ion implantation, for example as described in WO2015071487. Using this technique, NV⁻ centres are formed by nitrogen ion implantation and annealing (optionally including a vacancy generating irradiation step pre- or post-ion implantation) Ion implantation has a number of advantages over incorporating nitrogen into the crystal lattice during growth. A first advantage is a degree of control over the depth of the NV⁻ centres, which are required close to the surface. A second advantage is the ability to control where the nitrogen is implanted on the surface of the diamond, allowing nitrogen to be implanted in desired locations close to the expected locations of photonic structures. A third advantage is that ion implantation allows more control of the concentration of nitrogen in the diamond when low concentrations are desired (below 10¹⁵ cm⁻²). Of course, similar considerations are also made for the formation of other types of defect.
S4. The locations of the spin defects in the diamond layer 6 are mapped. The mapping can be achieved by characterizing the diamond layer 6 with micro-photoluminescence spectroscopy, and additionally using a self-correlation measurement to confirm the presence of a single defect in the volume of interest.
S5. A PIC 1 is prepared with photonic structures such as optical waveguides and photonic cavities located such that, after location of the diamond layer 6 on the PIC 1, the spin defects will be optically coupled to the corresponding optical structures in the insulating layer 1. Note that some of the optical structures may also be formed in the diamond layer 6.
S6. The alignment structures described above are used to locate the diamond layer 6 on the PIC 1.

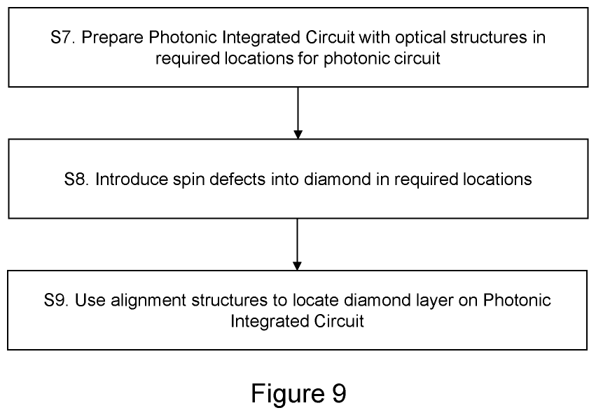

In a second example, optical structures are formed in the PIC 1 and spin defects are then introduced in the diamond in desired locations so as to be optically coupled to the optical structures in the insulating layer 1 after alignment and location of the diamond layer 6 on the PIC 1. FIG. 9 is a flow diagram showing exemplary steps for this method, with the following numbering corresponding to that of FIG. 9:
S7. A PIC 1 is prepared with photonic structures such as optical waveguides and photonic cavities located to form a photonic circuit.
S8. Spin defects are introduced into the diamond layer 6 in locations such that they will, after location of the diamond layer 6 on the PIC 1, be optically coupled to the corresponding photonic structures. These may be formed, for example, using the ion implantation techniques described above in step S3.
S9. The alignment structures described above are used to locate the diamond layer 6 on the PIC 1.

Note that steps S8 and S9 may be reversed; the spin defects may be formed in the diamond layer 6 before the location of the diamond layer 6 on the PIC 1, or alternatively the spin defects may be formed in the diamond layer 6 after the location of the diamond layer 6 on the PIC 1. However, note that while the ion implantation could be performed once the diamond layer 6 is already located on the PIC 1, thus not requiring any precise alignment between the diamond layer 6 and the PIC 1, but only alignment between the ion beam and the target, other defect generation steps may not be compatible with the photonic platform used. After implantation, an annealing step at high temperature (typically greater than 1000 °C) is required to recover most of the damage caused by the implantation and to diffuse the vacancies to form the ion-vacancy centres acting as spin defects. The annealing temperature may be above the thermal budget of the photonic platform, requiring that the annealing step is performed before the diamond layer 6 is located on the PIC 1 target.

An exemplary process flow can be summarised as follows:

A diamond substrate is appropriately processed to a required surface roughness, flatness, parallelism, strain, and subsurface damage.

The diamond substrate is implanted with light ions to create a damaged layer for subsequent electrochemical lift-off.

The diamond substrate is overgrown in a microwave plasma CVD reactor to create the high purity diamond layer 6.

Isolated defects are implanted (such as N, Si, Ge, or Sn) that can be subsequently processed to form spin defects.

The diamond layer 6 is annealed to generate the spin defects and to convert the damaged layer to graphite for subsequent electrochemical lift-off.

Alignment structures are fabricated in the diamond layer 6 with photo or e-beam lithography and ICP-RIE etching.

The locations of the spin defects in the diamond layer 6 are mapped using the alignment structures as reference.

Additional photonic structures are optionally fabricated in the diamond layer to create any waveguides and photonic cavities necessary for the photonic chip operation.

A layout of the target PIC 1 is created, and the PIC is fabricated.

Electrochemical lift-off of the diamond layer 6 is performed to remove the diamond substrate at the damaged layer.

The diamond layer 6 is aligned to the PIC 1 using transfer printing and a micromanipulator, while monitoring optical signals on the alignment waveguides in the PIC 1.

Further fabrication steps are carried out, such as the deposition of a cladding layer, the creation of strip microwave waveguides for spin defect control, or heterogeneous integration of other components such as single photon detectors or lasers or control electronics.

The processes described above allow the integration of large (>500 μm lateral size) diamond layers 6 membrane with a high thickness uniformity (inherent to the implantation and lift-off technique) onto a PIC 1 to form a photonic circuit. The lateral size of the is mainly limited by the size of the starting single crystal substrate. Additionally, the fabrication using implantation and lift-off offers greater thickness uniformity over large areas compared to mechanical polishing or ICP-RIE etching. Thickness uniformity is a critical factor in this application because it guarantees uniform optical performance, such as mode volume, effective refractive index, and resonant frequencies, across the entire area of the membrane and between different membranes, making the photonic platform robust for volume fabrication.

As diamond layers are used with large surface areas, alignment becomes more difficult and more critical. The use of alignment structures as described above allows for alignment of large diamond layers with a largest linear dimension of greater than 500 μm.

While this invention has been particularly shown and described with reference to embodiments, it will be understood by those skilled in the art that various changes in form and detail may be made without departing from the scope of the invention as defined by the appended claims.

1. A heterogeneously integrated photonic circuit comprising:
a Photonic Integrated Circuit;
a single crystal diamond layer disposed on the Photonic Integrated Circuit, the single crystal diamond substrate comprising at least one spin defect, the single crystal diamond having a largest surface with a surface area of at least 250,000 μm²;
wherein the Photonic Integrated Circuit comprises at least one Photonic Integrated Circuit alignment structure and the single crystal diamond layer comprises at least one corresponding diamond alignment structure; and
the Photonic Integrated Circuit further comprises at least one photonic structure optically coupled to the at least one spin defect.

2. The photonic circuit according to claim 1, wherein the spin defect is selected from any of a negatively charged nitrogen-vacancy centre, a silicon vacancy centre, a germanium vacancy centre, a tin vacancy centre, a nickel vacancy NE4, and a nickel vacancy nitrogen defects, NE8.

3. The photonic circuit according to claim 1, comprising a plurality of spin defects and a plurality of corresponding photonic structures, wherein the plurality of photonic structures are configured to connect different spin defects in accordance with quantum computing protocols.

4. The photonic circuit according to claim 1, wherein the photonic structure is selected from any of an optical waveguide and a photonic cavity.

5. The photonic circuit according to claim 1, wherein the single crystal diamond layer has a thickness selected from any of between 50 nm and 50 μm, 100 nm and 10 μm, and 150 nm and 5 μm.

6. The photonic circuit according to claim 1, wherein the Photonic Integrated Circuit alignment structure and the diamond alignment structure comprise corresponding structures that allow light to pass through when the alignment structures are aligned.

7. The photonic circuit according to claim 6, wherein the Photonic Integrated Circuit alignment structure and the diamond alignment structure comprise corresponding diffraction gratings arranged to diffract light during alignment.

8. The photonic circuit according to claim 6, wherein the Photonic Integrated Circuit alignment structure and the diamond alignment structure comprise corresponding waveguide couplers in the diamond layer to connect optical waveguides in the Photonic Integrated Circuit.

9. The photonic circuit according to claim 6, wherein the Photonic Integrated Circuit alignment structure and the diamond alignment structure comprise alignment markers.

10. The photonic circuit according to claim 6, wherein the Photonic Integrated Circuit alignment structure and the diamond alignment structure are formed using any of implantation, electron beam lithography and inductively couple plasma reactive ion etching.

11. The photonic circuit according to claim 1, wherein the single crystal diamond layer has a largest surface area selected from any of at least 500,000 μm² , 1 mm², 4 mm², 25 mm² and 100 mm².

12. The photonic circuit according to claim 1, wherein a plurality of single crystal diamond layers are disposed on the Photonic Integrated Circuit.

13. A method of forming a photonic circuit, the method comprising:
providing a Photonic Integrated Circuit;
disposing a single crystal diamond layer on the Photonic Integrated Circuit by aligning a diamond alignment structure in the diamond layer with a corresponding Photonic Integrated Circuit alignment structure in the PIC;
wherein the single crystal diamond layer has a largest surface with a surface area of at least 250,000 μm²; and comprises at least one spin defect, the spin defect being optically coupled to an optical waveguide in the Photonic Integrated Circuit.

14. The method according to claim 13, wherein the spin defect is selected from any of a negatively charged nitrogen-vacancy centre, a silicon vacancy centre, a germanium vacancy centre, a tin vacancy centre, a nickel vacancy NE4, and a nickel vacancy nitrogen defects, NE8.

15. The method according to claim 13, wherein the diamond layer comprises a plurality of spin defects and the Photonic Integrated Circuit comprises a plurality of corresponding photonic structures, wherein the plurality of photonic structures are configured to connect different spin defects in accordance with quantum computing protocols.

16. (canceled)

17. The method according to claim 13, wherein the Photonic Integrated Circuit alignment structure and the diamond alignment structure comprise corresponding structures that allow light to pass through when the alignment structures are aligned, and the alignment step comprises passing light through the alignment structures.

18-20. (canceled)

21. The method according to claim 13, further comprising, prior to aligning the diamond alignment structure in the diamond layer with a corresponding Photonic Integrated Circuit alignment structure in the Photonic Integrated Circuit, forming any Photonic Integrated Circuit alignment structure and the diamond alignment structure using any of implantation, electron beam lithography and inductively couple plasma reactive ion etching.

22. The method according to claim 13, further comprising disposing a plurality of single crystal diamond layers on the Photonic Integrated Circuit.

23. The method according to claim 13, comprising, prior to disposing the diamond layer on the Photonic Integrated Circuit:
forming the spin defect in the diamond layer;
mapping the location of the spin defect in the diamond layer; and
forming the photonic structure in the Photonic Integrated Circuit to correspond to the location of the spin defect such that the spin defect and the photonic structure are optically coupled after disposing the diamond layer on the Photonic Integrated Circuit.

24. The method according to claim 13, comprising:
forming the photonic structure in the Photonic Integrated Circuit;
disposing the diamond layer on the Photonic Integrated Circuit; and
forming the spin defect in the diamond layer such that the spin defect and the photonic structure are optically coupled.
